(19) United States
(12) Patent Application Publication
(10) Pub. No.: US 2008/0145595 A1
(43) Pub. Date: Jun. 19, 2008

(54) Composite pedestal base assembly

(76) Inventors: Charles F. Pratt, Granville, OH (US); Malcolm W. Rosenow, Winona, MN (US); Richard Kwiatkowski, Lawrenceville, GA (US)

Correspondence Address: OWENS CORNING, 2790 COLUMBUS ROAD, GRANVILLE, OH, 43023, US

(21) Appl. No.: 11/638,929

(22) Filed: Dec. 14, 2006

(51) Int. Cl. B28B 23/00

(52) U.S. Cl. 428/109; 264/109; 264/241; 264/570

(57) ABSTRACT

An appliance base assembly includes a one-piece composite body having at least one molded in feature selected from a group consisting of a front-face plate, a mounting bracket, an insulation retention tab, an air circulation vent and combinations thereof.

### TECHNICAL FIELD AND INDUSTRIAL APPLICABILITY OF THE INVENTION

The present invention relates generally to an appliance base assembly or composite pedestal base assembly incorporating various molded in features.

### BACKGROUND OF THE INVENTION

Composite materials have long been used to mold base assemblies and other structures for home electrical appliances, office automation equipment and interior automotive trims. U.S. Pat. No. 5,030,682 to Nomura et al. discloses a glass fiber reinforced polyolefin resin composition for just such a purpose. U.S. Pat. No. 6,811,195 to Klocke et al. discloses a thermal plastic composite structural article that may be used, for example, in domestic appliances. U.S. Pat. No. 4,295,692 to Jenkins and U.S. Pat. No. 6,546,942 to Smith et al. both disclose dishwashers that incorporate plastic frames.

The present invention relates to a pedestal base assembly that incorporates molded in features not previously found in the prior art. Such a base assembly offers cost savings based upon consolidation of function, elimination of parts and reduced assembly costs.

### SUMMARY OF THE INVENTION

In accordance with the purposes of the present invention described herein, an improved pedestal base assembly is provided. The base assembly comprises a 1-piece composite body having at least one molded-in feature selected from a group consisting, of a front face plate, a mounting bracket, an insulation retention tab, an air circulation vent and combinations thereof. More specifically, the composite body is made from reinforcing fibers and a matrix binder. The reinforcing fibers are selected from a group of fibers consisting of glass fibers, aramid fibers, carbon fibers, natural fibers, metal fibers, hemp fibers, kanaf fibers and mixtures thereof. Typically the reinforcing fibers have an average length of at least 1.00 mm. The reinforcing fibers also typically have a diameter of between about 5 and about 20 microns.

The matrix binder may be a thermoset polymer or a thermoplastic polymer. The matrix binder may be selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic molding compound, dicyclopentadiene and mixtures thereof. The matrix binder may be in the form of a powder and/or a fiber. The matrix binder may also include bicomponent fibers.

In accordance with yet an additional aspect of the present invention a method is provided for making a base assembly. The method comprises molding a one-piece composite body having at least one molded in feature selected from a group consisting of a front face plate, a mounting bracket, an insulation retention tab, an air circulation vent and combinations thereof. The molding of the body may be performed using a composite material including reinforcing fibers and a matrix binder. A bulk-molding compound or a sheet-molding compound may be used in the process. Further, the molding may be by injection molding or compression molding depending on the material used in the process.

In accordance with yet another aspect of the present invention, an oven range assembly is provided comprising an oven range and a base assembly including a one-piece composite body having at least one molded-in feature selected from a group consisting of a front faceplate, a mounting bracket, an insulation retention tab, an air circulation vent and combinations thereof. The oven range assembly may further include an insulation blanket and a storage drawer.

In the following description there is shown and described preferred embodiments of this invention, simply by way of illustration of several of the modes best suited to carry out the invention. As it will be realized, the invention is capable of other different embodiments and its several details are capable of modification in various, obvious, aspects all without departing from the invention. Accordingly, the drawings and description will be regarded as illustrative in nature and not as restrictive.

### BRIEF DESCRIPTION OF THE DRAWING

The accompanying drawing incorporated and forming a part of the specification, illustrates several aspects of the present invention and together with the description serves to explain certain principles of the invention. In the drawing:

FIG. 1 is a detailed perspective view of the pedestal base assembly of the present invention; and

FIG. 2 is an exploded perspective view illustrating the pedestal base assembly of FIG. 1 with an oven range, insulation blanket and storage drawer.

Reference will now be made in detail to the present preferred embodiments of the invention, examples of which are illustrated in the accompanying drawing.

### DETAILED DESCRIPTION AND PREFERRED EMBODIMENTS OF THE INVENTION

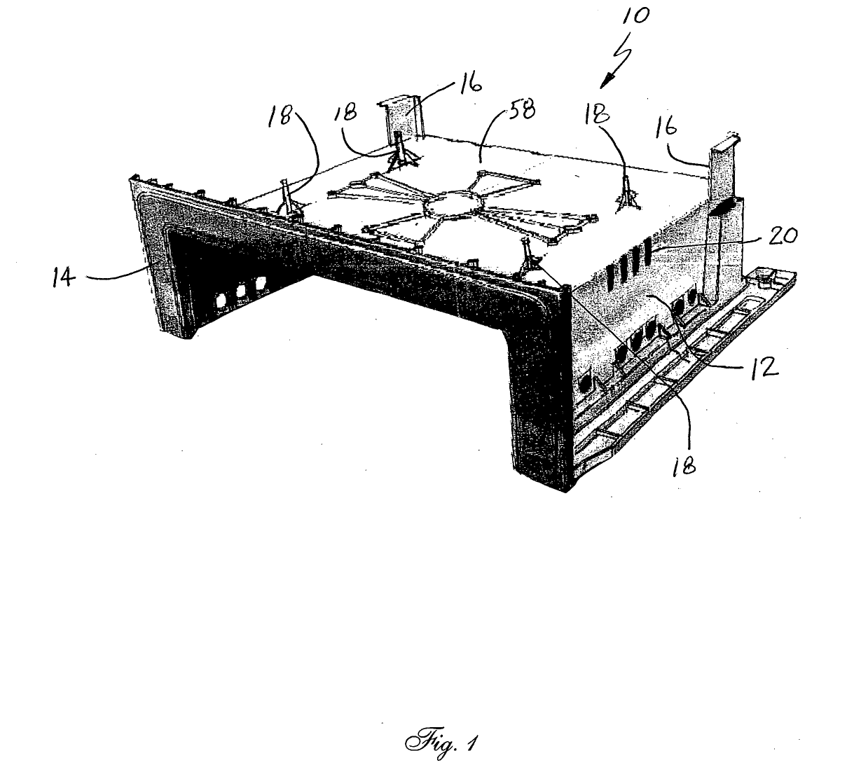

Reference is now made to FIG. 1, which illustrates the pedestal base assembly of the present invention generally designated by reference numeral 10. The pedestal base assembly 10 includes a 1-piece composite body 12 made from reinforcing fibers and a matrix binder. The 1-piece composite body 12 has at least one molded in feature selected from a group consisting of a front-face plate 14, a mounting bracket 16 (two are illustrated), an insulation retention tab 18 (four are illustrated), an air circulation vent 20 and combinations thereof.

The reinforcing fibers used in the construction of the composite body 12 may be selected from a group including but not limited to glass fibers, aramid fibers, carbon fibers, natural fibers such as hemp fibers and kanaf fibers, metal fibers and mixtures thereof. Typically, the reinforcing fibers have an average length of at least 1.00 mm. The reinforcing fibers also typically have a diameter of between about 5 and about 20 microns. Typically long glass fibers are utilized. Those fibers may be made from E-glass and S-glass. The fibers may be used in the form of chopped strands or individual chopped filaments.

The matrix binder used in the composite body 12 may be a thermoset polymer or a thermoplastic polymer. Typically the matrix binder is selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic molding compound, dicyclopentadiene and mixtures thereof. The matrix binder may be used in liquid form, powder form, pellet form, fiber form and/or bi-component fiber form. The physical form of these matrix materials (i.e., their viscosities, particle sizes, etc.) is well-known in the art, variable to be compatible with the particular molding process chosen, and typical of “standard” matrix materials known in the industry. Typically the composite body 12 comprises between about 20 and about 50 weight % reinforcing fibers and between about 50 and about 80 weight % matrix binder. The composite body 12 has a density of between about 1.0 g/cm³ and about 2.0 g/cm³.

The composite pedestal base assembly or appliance base assembly 18 may be molded using various materials including a mixture of reinforcing fibers and matrix binder, a bulk-molding compound or a sheet-molding compound. Thus, molding methods include but are not limited to injection and compression molding. By molding in features such as the front-face place 14, the mounting brackets 16, the insulation retention tabs 18 and the air circulation vent 20 it is possible to produce a base assembly 10 with these important features in a single step process. This enhances the functionality of the molded product and significantly reduces manufacturing costs.

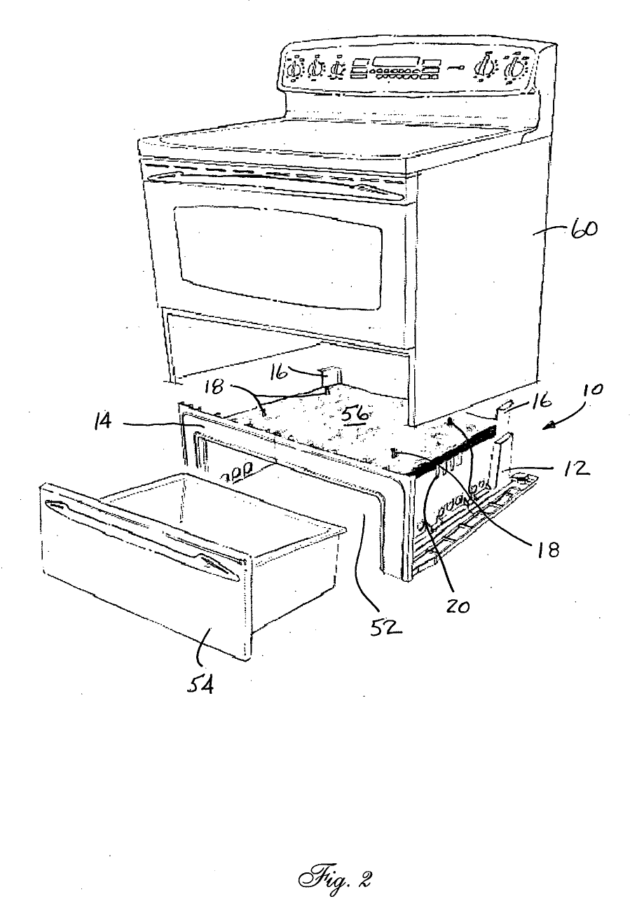

An oven range assembly, generally designated by reference numeral 50 is illustrated in FIG. 2. The oven range assembly 50 includes the pedestal base assembly 10 of the present invention. As illustrated, the base assembly 10 includes an open cavity 52 for receiving and holding a storage drawer 54 (see also FIG. 1).

A blanket of insulation 56 is secured along the upper wall 58 of the base assembly 10. The insulation blanket 56 is held in position by means of the insulation retention tabs 18 which penetrate the blanket material. Together, the insulation blanket 56 and air circulation vent 20 function to maintain reduced temperatures in the storage drawer 54 during operation of the oven range 60.

The oven range 60 is secured to the pedestal base assembly 10 by means of the mounting brackets 16. More specifically, fasteners (not shown) are used to secure the housing of the oven range 60 to the brackets 16 and complete the connections.

The foregoing description of preferred embodiments of the invention has been presented for purposes of illustration and description. It is not intended to be exhaustive or to limit the invention to the precise form disclosed. Obvious modifications or variations are possible in light of the above teachings. For example, the pedestal base assembly 10 illustrated and described above is for an oven range. Such a base assembly 10 could also be provided for other electrical appliances including but not limited to a dishwasher, clothes washer, clothes dryer, a refrigerator, a freezer or the like. Further, such a pedestal base assembly 10 could be equipped with other molded in features including but not limited to a drawer slide, hose clamps and the like.

The embodiments were chosen and described to provide the best illustration of the principles of the invention and its practical application to thereby enable one of ordinary skill in the art to utilize the invention in various embodiments and with various modifications as is suited a particular use contemplated. All such modifications and variations are within the scope of the invention as determined by the appended claims when interpreted in accordance with the breadth to which they are fairly, legally and equitably entitled.

What is claimed:

1. A base assembly, comprising:
a one-piece composite body having at least one molded-in feature selected from a group consisting of a front faceplate, a mounting bracket, an insulation retention tab, an air circulation vent and combinations thereof.

2. The base assembly of claim 1, wherein said composite body is made from reinforcing fibers and matrix binder.

3. The base assembly of claim 2, wherein said reinforcing fibers are selected from a group of fibers consisting of glass fibers, aramid fibers, carbon fibers, natural fibers, metal fibers, hemp fibers, kenaf fibers and mixtures thereof.

4. The base assembly of claim 3, wherein said matrix binder is a thermoset polymer.

5. The base assembly of claim 3, wherein said matrix binder is a thermoplastic polymer.

6. The base assembly of claim 3, wherein said matrix binder is selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic molding compound, dicyclopentadiene and mixtures thereof.

7. The base assembly of claim 3, wherein said reinforcing fibers have an average length of at least 1.00 mm.

8. The base assembly of claim 7, wherein said matrix binder is in a powder form.

9. The base assembly of claim 7, wherein said matrix binder is in a fiber form.

10. The base assembly of claim 7, wherein said matrix binder includes bicomponent fibers.

11. The base assembly of claim 2, wherein said matrix binder is selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic molding compound, dicyclopentadiene and mixtures thereof.

12. The base assembly of claim 11, wherein said reinforcing fibers have an average length of at least 1.00 mm.

13. The base assembly of claim 12, wherein said matrix binder is in a powder form.

14. The base assembly of claim 12, wherein said matrix binder is in a fiber form.

15. The base assembly of claim 12, wherein said matrix binder includes bicomponent fibers.

16. A method of making a base assembly, comprising:
molding a one-piece composite body having at least one molded-in feature selected from a group consisting of a front face plate, a mounting bracket, an insulation retention tab, an air circulation vent and combinations thereof.

17. The method of claim 16, including molding said body from a composite material including reinforcing fibers and matrix binder.

18. The method of claim 16, including molding said body from a bulk-molding compound.

19. The method of claim 16, including molding said body from a sheet-molding compound.

20. The method of claim 16, including molding by injection molding.

21. The method of claim 16, including molding by compression molding.

22. An oven range assembly, comprising:
an oven range; and
a base assembly including a one-piece composite body having at least one molded-in feature selected from a group consisting of a front faceplate, a mounting bracket, an insulation retention tab, an air circulation vent and combinations thereof.

23. The oven range assembly of claim 22 further including an insulation blanket held on said base assembly by said insulation retention tabs.

24. The oven range assembly of claim 22, further including a storage drawer received in said base assembly.
